(19) United States
(12) Patent Application Publication
(10) Pub. No.: US 2026/0086623 A1
(43) Pub. Date: Mar. 26, 2026

(54) PROCESSING METHOD AND ELECTRONIC DEVICE

(71) Applicant: Lenovo (Beijing) Limited, Beijing (CN)

(72) Inventor: Lei LU, Beijing (CN)

(21) Appl. No.: 19/204,393

(22) Filed: May 9, 2025

(30) Foreign Application Priority Data
May 29, 2024 (CN) 202410683767.2

(51) Int. Cl. G06F 1/3293

(52) U.S. Cl. CPC G06F 1/3293

(57) ABSTRACT

A processing method comprising, based on an power consumption mode switching request of a first device, switching the first device from a first processing mode to a second processing mode, and in response to the power consumption mode switching request, switching a power consumption mode of the first device from a first mode to a second mode. In the first processing mode, a processing frequency of the first device for a signal received from a second device is a first frequency. In the second processing mode, the processing frequency of the first device for the signal received from the second device is a second frequency. The second frequency is lower than the first frequency. The second mode has lower power consumption than the first mode.

### CROSS-REFERENCE TO RELATED APPLICATION

The present disclosure claims priority to Chinese Patent Application No. 202410683767.2, filed on May 29, 2024, the entire content of which is incorporated herein by reference.

### TECHNICAL FIELD

The present disclosure is related to the electronic device technology field and, more particularly, to a processing method and an electronic device.

### BACKGROUND

Often, a host electronic device is electrically connected or signal-connected to an external device to perform data exchange. However, when the external device and the host device are in certain connection modes, the external device exchanges data with the host device frequently. This causes the host device to be unable to automatically enter a low power mode (e.g., a sleep mode, energy saving mode, etc.) and unable to meet the energy saving requirement of the device.

### SUMMARY

An aspect of the present disclosure provides a processing method. The method includes, based on a power consumption mode switching request of a first device, switching the first device from a first processing mode to a second processing mode, and in response to the power consumption mode switching request, switching a power consumption mode of the first device from a first mode to a second mode. In the first processing mode, a processing frequency of the first device for a signal received from a second device is a first frequency. In the second processing mode, the processing frequency of the first device for the signal received from the second device is a second frequency. The second frequency is lower than the first frequency. The second mode has lower power consumption than the first mode.

An aspect of the present disclosure provides an electronic device, including one or more processors and one or more memory. The one or more memories storing a program that, when executed by the one or more processors, causes the one or more processors to, based on an power consumption mode switching request of a first device, switch the first device from a first processing mode to a second processing mode, and in response to the power consumption mode switching request, switch a power consumption mode of the first device from a first mode to a second mode. In the first processing mode, the processing frequency of the first device for a signal received from a second device is a first frequency. In the second processing mode, the processing frequency of the first device for the signal received from the second device is a second frequency. The second frequency is lower than the first frequency. The second mode has lower power consumption than the first mode.

### BRIEF DESCRIPTION OF THE DRAWINGS

FIG. 1 illustrates a schematic flowchart of a processing method according to some embodiments of the present disclosure.

FIG. 2 illustrates a schematic flowchart of a first type processing method according to some embodiments of the present disclosure.

FIG. 3 illustrates a schematic flowchart of a second type processing method according to some embodiments of the present disclosure.

FIG. 4 illustrates a schematic flowchart of a third type processing method according to some embodiments of the present disclosure.

FIG. 5 illustrates a schematic flowchart of a processing method in an application scenario according to some embodiments of the present disclosure.

FIG. 6 illustrates a schematic flowchart of a processing method of controlling a second device to change a device form according to some embodiments of the present disclosure.

FIG. 7 illustrates a schematic flowchart of a processing method of calling some device parameters in a processor of a second device according to some embodiments of the present disclosure.

FIG. 8 illustrates a schematic flowchart of a processing method of a processor of a first device lowering a processing frequency according to a target signal according to some embodiments of the present disclosure.

FIG. 9 illustrates a schematic diagram showing some device parameters in a processor of a first device called in a processing method according to some embodiments of the present disclosure.

### DETAILED DESCRIPTION OF THE EMBODIMENTS

Exemplary embodiments of the present disclosure are described in detail below with reference to the accompanying drawings. Although the drawings illustrate exemplary embodiments of the present disclosure, the present disclosure can be implemented in various methods and should not be limited by the described embodiments below. On the contrary, these embodiments are provided to enable a more thorough understanding of the disclosure and to fully convey the scope of the disclosure to those skilled in the art.

Unless otherwise specified, the technical or scientific terms used in the present disclosure shall have the ordinary meanings understood by those skilled in the art.

In the description of the present specification, references terms such as “one embodiment,” “some embodiments,” “example,” “specific example,” or “some examples” mean that specific features, structures, materials, or characteristics described in connection with the embodiment or example are included in at least one embodiment or example of the present disclosure. Moreover, the described specific features, structures, materials, or characteristics may be combined in any suitable manner in one or more embodiments or examples. Furthermore, without contradiction, those skilled in the art may combine and integrate the different embodiments or examples described in the present specification as well as the features of different embodiments or examples.

Additionally, the terms “first” and “second” are used for descriptive purposes only and should not be construed as indicating or implying relative importance or implicitly specifying the quantity of the indicated technical features. Thus, features defined by “first” or “second” may explicitly or implicitly include at least one of such features. In the description of the present disclosure, “a plurality of” means two or more, unless otherwise explicitly and specifically defined.

In related technologies, when an external device and a host device are in a certain connection mode, the external device may frequently exchange data with the host device, which prevents the host device from automatically entering a low-power mode (e.g., a sleep mode, power-saving mode, etc.), thereby failing to meet energy-saving requirements. For example, a gaming handheld device and a game controller can be data-interconnected via wired or wireless connections. Regardless of whether the game controller is directly connected to the gaming handheld device via a cable or wirelessly via Bluetooth, based on design conventions, the gaming handheld device can consider the game controller as a USB device by default to ensure data transmission and response rates when the gaming handheld device and the game controller are directly and electrically connected. However, in practical applications, the gaming handheld device can configure an operation mode of the game controller according to the requirements of the running game, such as an XBOX mode. In the XBOX mode, the game controller (i.e., the second device) will continuously send a status signal to the gaming handheld device (i.e., the first device) at a certain frequency (referred to as the original frequency in subsequent content). The first device will process the signals received from the second device at the same first frequency as the signal transmission frequency of the second device. Thus, even if the game controller (i.e., the second device) is not in operation, the above data exchange process can continue, and the gaming handheld device can remain in an active status, keep a high power consumption status, and cannot enter the sleep or low-power mode.

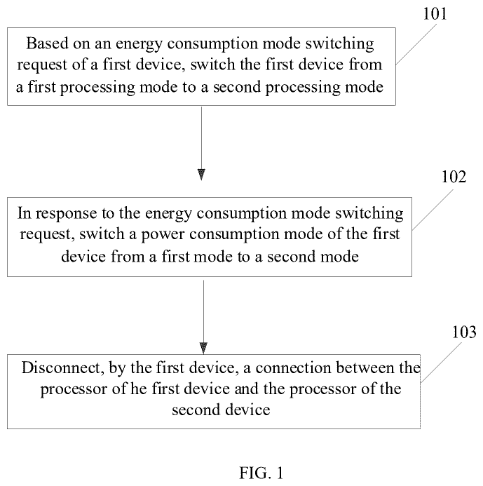

To address the above technical problem, embodiments of the present disclosure provide a processing method. With reference to FIG. 1, the method includes the following steps.

At 101, based on a power consumption mode switching request of the first device, the first device is switched from a first processing mode to a second processing mode. In the first processing mode, the first device processes signals received from the second device at a first frequency. In the second processing mode, the first device processes the signals received from the second device at a second frequency. The second frequency is lower than the first frequency.

In some embodiments, the first device can include, but is not limited to, a gaming handheld device, a mobile phone, a laptop, and other terminal devices. The second device can be a device capable of establishing a signal connection with the first device for data exchange, which can include, but is not limited to, a game controller, a keyboard, a mouse, and another external device. In the following description of embodiments of the present disclosure, the gaming handheld and game controller can be taken as examples for a detailed description.

In the processing method of embodiments of the present disclosure, a relevant execution method can be set in the processor of the first device. When receiving a power consumption mode switching request, the processing frequency of a signal received from the second device can be lowered, after which the power mode of the first device is switched from a higher level to a lower level. Thus, even if the second device is in a special status or a specific device form (i.e., the aforementioned USB device status) and in the XBOX mode, the first device can still reduce power consumption. In some embodiments, the power consumption mode switching request can include, but is not limited to, the sleep mode, the low-battery mode, etc. The power consumption mode switching request can be triggered by a user clicking a relevant button or area, by the low-battery state of the first device, or when the user is away without operating the second device or the first device for an extended period. The first device can receive all signals sent by the second device but may not process the signals in real time. The first frequency can be the same as the signal transmission frequency of the second device or lower than the signal transmission frequency of the second device. The second frequency can be lower than the first frequency. The second frequency can also be zero. In some embodiments, the method of lowering the data processing frequency can include changing the connection status of the second device to the Bluetooth connection status with the signal transmission frequency lower than the USB connection status, or directly lowering the signal processing frequency of the first device.

At 102, in response to the power consumption mode switching request, the power mode of the first device is switched from a first mode to a second mode. The second mode has lower power consumption than the first mode.

The gaming handheld device and the game controller can be data-interconnected via a wired or wireless connection. During use, the gaming handheld device can configure the operation mode of the game controller according to the requirements of the running game, such as the XBOX mode. In the XBOX mode, the game controller (i.e., the second device) can continuously send a status signal to the gaming handheld device (i.e., the first device) at a certain frequency (referred to as the original frequency in subsequent content). The first device can process the signals received from the second device at the first frequency, which is the same as the signal transmission frequency of the second device. Then, even if the game controller (i.e., the second device) is not in operation, the above data transmission and reception process can continue. When the original frequency is high enough to prevent the first device from entering the sleep mode, the first device (e.g., the gaming handheld device) can remain in an active status, maintain the high power consumption status, and cannot enter the sleep mode or the low-power consumption mode. After the processing mode is switched in step 101, the processing frequency of the first device for the transmission signal of the second device can be lowered. In the frequency interval, the first device can switch the power consumption mode of the first device from the first mode with high power consumption to the second mode with lower power consumption to allow the first device to sleep or operate with low power to reduce the power consumption. Those skilled in the art can understand that the first device switched the power consumption mode of the first device, which is not repeated here.

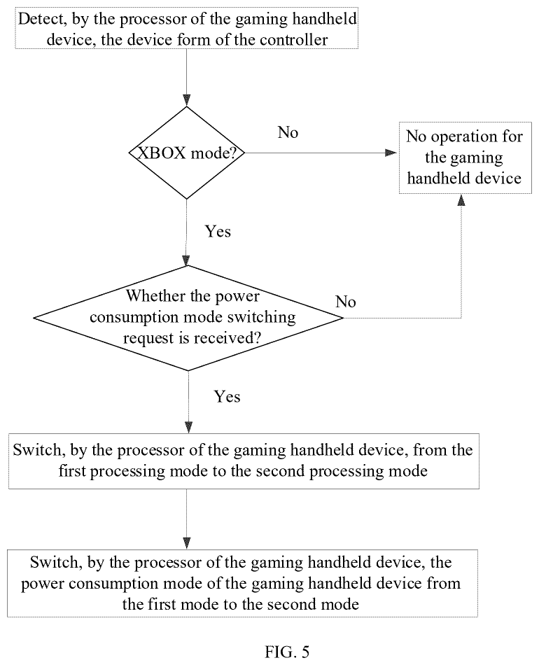

In some embodiments, as shown in FIG. 5, based on a specific implementation scenario of the above processing method, after the gaming handheld device is connected to the game controller, the gaming handheld device can automatically configure the device mode of the controller (e.g., the XBOX mode, etc.) according to the requirements of the running game. That is, the button functions of the controller can be reconfigured, which is easily understood by those skilled in the art and is not repeated here. When the gaming handheld device receives a power consumption mode switching request while the controller is in the XBOX mode, the processor of the gaming handheld device can switch the processing mode for the signals sent from controller from the first processing mode to the second processing mode to reduce the processing frequency for the signal sent by the controller. Further, the power consumption mode of the gaming handheld device can be switched from the first mode to the second mode to reduce the power consumption. Correspondingly, when the controller is not in the XBOX mode, the controller may not continuously send a status signal to the gaming handheld device to prevent the gaming handheld device from switching to the low power consumption mode. Thus, when the gaming handheld device receives the power consumption mode switching request, the processing mode of the gaming handheld device may not need to be switched for the signal sent by the controller.

Based on the above, in the processing method of the first aspect of the present disclosure, the signal processing frequency of the second device can be lowered from the higher first frequency to the second frequency based on the power consumption mode switching request of the first device, while simultaneously switching the power mode of the first device from a higher first mode to a lower second mode to reduce power consumption. Then, the following problem can be addressed. When in certain connection modes, the external device can frequently exchange data with the host device to prevent the host device from entering the sleep or power-saving mode. Then, the power saving requirement cannot be met, and a mistouch can easily occur to reduce the user experience.

In the present specification, the term “and/or” is merely a description of the association relationship between related objects and indicates that three relationships may exist. For example, “A and/or B” can be understood as including any one of situations, such as both A and B, only A, or only B.

In some embodiments, referring to FIG. 1, the processing method of embodiments of the present disclosure further includes step 103 after step 102.

At 103, the processor of the first device disconnects the connection with the processor of the second device.

After the first device reduces the processing frequency of the first device for the signal sent by the second device, except for setting the second frequency to zero, the first device can still be awakened for data processing after the interval frequency ends. For example, if the second frequency is 15 s/time, the first device can be awakened every 15 seconds for data processing. To ensure that the first device remains in the second mode after responding to the power consumption mode switching request to reduce power consumption, step 103 can be implemented in embodiments of the present disclosure. After the processing frequency is reduced, the connection between the first device and the second device can be disconnected. That is, the processor of the first device can remove the second device from the device list and cut off signal transmission between the first device and the second device to ensure the first device remains in the second mode.

In some embodiments, the method for reducing the processing frequency of the first device for a signal sent from the second device based on the power consumption mode switching request can include at least the following three methods.

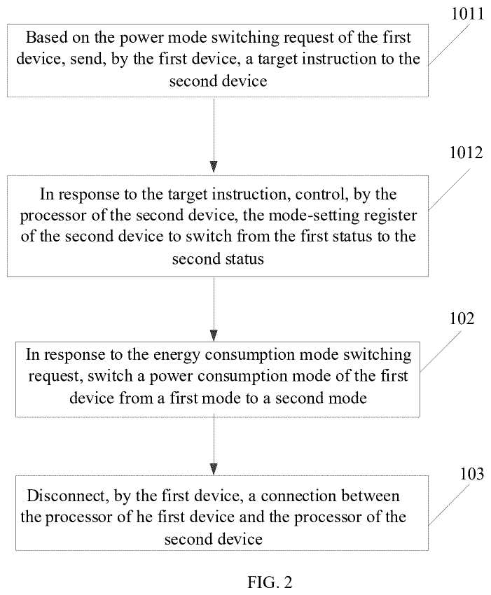

First, referring to FIG. 2, step 101 includes the following steps.

At 1011, based on the power consumption mode switching request of the first device, the first device sends a target instruction to the second device.

To allow the first device to reduce the processing frequency for the signal sent by the second device, the recognized status of the second device can be changed in the first device in embodiments of the present disclosure. For example, the wireless device can have a lower signal transmission frequency compared to the wired device. Based on the design conventions of the gaming handheld device and game controller, the game controller can typically be recognized by the gaming handheld device as a USB device. In a special mode, the second device can frequently send signals to the first device via a wired channel or a wireless Bluetooth channel. That is, the data processing frequency of the first device can be the first frequency. Then, the first device can control the second device to change the status of the second device into the Bluetooth connection status to perform data exchange with the first device through the wireless Bluetooth channel. The signal transmission frequency of the Bluetooth device can be smaller than the signal transmission frequency of the USB device. Then, the first device can maintain a frequency the same as the signal transmission frequency of the second device to perform the data processing. The second frequency can be the frequency at which the Bluetooth device sends the signal through the wireless Bluetooth channel to complete the switching of the power mode. The first device can also reduce the frequency according to the predetermined target frequency of the first device. Thus, the target instruction can include a device status switching instruction.

At 1012, in response to the target instruction, the processor of the second device controls the mode-setting register of the second device to switch from the first status to the second status. In the first status, the first device is in the first processing mode, while in the second status, the first device is in the second processing mode.

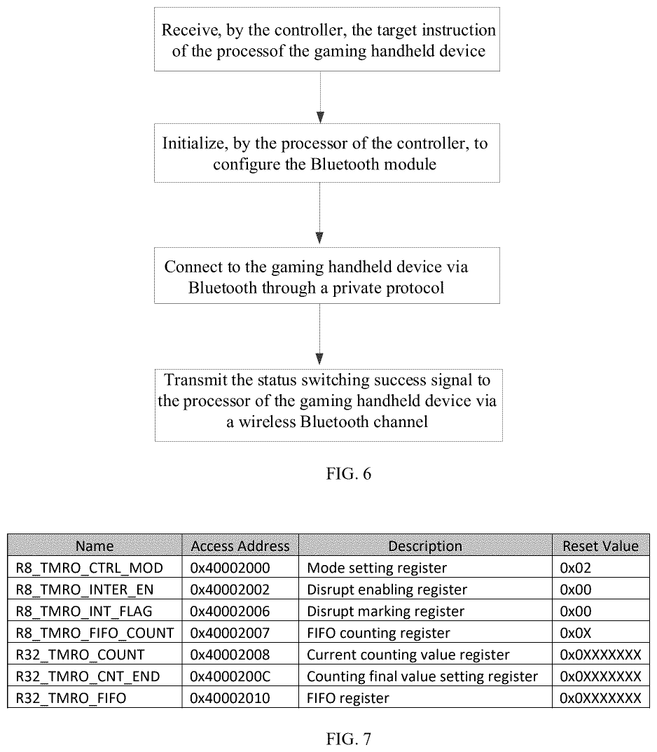

After receiving the target instruction, the processor of the second device can control the mode-setting register to switch from the first status (i.e., USB status) to the second status (i.e., wireless Bluetooth status). The first status and the second status may differ for different first devices and second devices, and the first status and the second status can be pre-stored in the mode-setting register, which also includes data corresponding to the status, such as the function module format, version, transmission rate, etc., corresponding to the Bluetooth state, which are pre-stored as a set corresponding to the status, and can be called, switched, and restored according to the target instruction. That is, the Bluetooth module can be initialized or refreshed. As shown in FIG. 6, after the second device switches the device status of the second device into the Bluetooth status, the second device is connected to the first device via the wireless Bluetooth channel and sends the status switching success signal to allow the first device to identify the second device as a Bluetooth device. During this process, the second device can be directly connected to the first device through a private protocol without the pairing confirmation of the first device. This setting can be understood by those skilled in the art and is not repeated here. When the second device and the first device are originally in the wired connection status, the second device can retain the wired connection, and meanwhile, the second device can be connected to the first device via the wireless Bluetooth channel after changing the status of the device of the second device. The original signal can still be transmitted in the wired connection channel according to the high priority of the wired data transmission to ensure the response rate. The status switching success signal of the second device can be sent to the first device independently via the wireless Bluetooth channel. When the second device and the first device are originally in the wireless connection status, the second device can be reconnected to the first device via the wireless Bluetooth channel after changing the device status of the second device. That is, the original XBOX mode can be removed. Subsequently, when the second device needs to be reactivated, the second device may need to be controlled to change the device status of the second device into the USB device.

In some embodiments, referring to FIGS. 6 and 7, regardless of whether the controller and the gaming handheld device are in the wired or wireless connection status, the specific processing method based on the above content includes the following steps.

When the controller is in the XBOX mode, the reset value in the mode-setting register of the processor can be changed to a non-0X00 value. After the processor of the controller receives the status switching instruction sent by the processor of the gaming handheld device, the processor of the controller can reset the mode-setting register back to 0X00. That is, the Bluetooth module can be initialized to maintain the Bluetooth device status. Of course, the form, version, transmission rate, etc., of the functional module corresponding to the controller can be reset in the corresponding register. The setting can be easily understood by those skilled in the art. The reset value of the mode setting register can be adjusted as needed, which can be easily understood by those skilled in the art and is not repeated here.

In some embodiments, step 1011 can be performed in the following methods.

In the first method, the processor of the first device can send the target instruction to the processor of the second device through the first channel.

Since the processor of the first device and the processor of the second device originally have a data interaction channel, e.g., a wired or wireless channel, the first device can send the target instruction to the processor of the second device directly using the original data interaction channel.

In a second method, the processor of the first device can send the target instruction to the processor of the second device via the second channel. The second channel is different from the first channel, and the second channel is only configured to transmit the target instruction.

To simplify program design, in embodiments of the present disclosure, the second channel configured to independently transmit the target instruction different from the first channel can be configured. For example, the first interface can be set for GPIO or PCIE in the processor of the first device to cause the processor of the first device, the first port, and the processor of the second device to form the second channel. The data transmission and reception program may not need to be modified for the processor of the first device. Thus, the design can be simplified. The first port can be an existing port in the processor of the first device or a newly added, and can be connected through a cable.

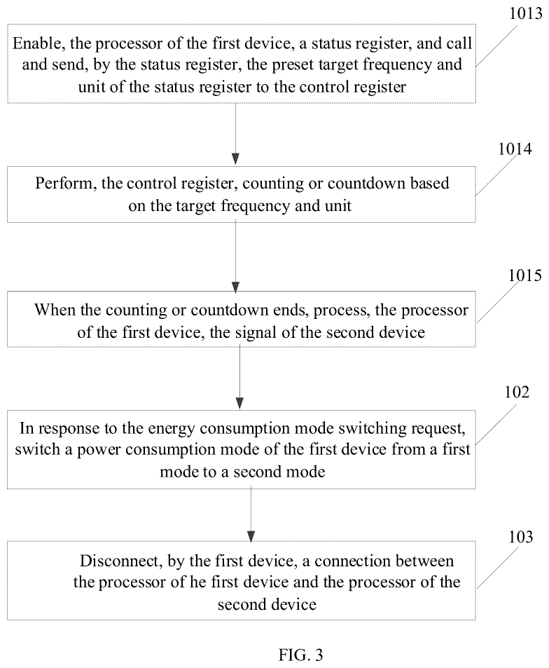

In the second method, referring to FIG. 3, step 101 includes the following steps.

At 1013, the processor of the first device enables a status register. The status register calls and sends the preset target frequency and unit of the status register to the control register. The target frequency is lower than the signal processing frequency of the processor of the first device for the second device when the first device does not respond to the power consumption mode switching request.

To enable the first device to control itself to reduce the signal processing frequency for the second device, in the method of embodiments of the present disclosure, the processor of the first device can directly control the status register to call and send the pre-stored target frequency (value) and unit (time unit) of the status register to the control register. The status register can be a system count status register, and the control register can be a system count control register. The status register can have a storage function and can pre-store the target frequency and the original frequency. The original frequency can be the signal processing frequency of the processor of the first device for the second device without responding to the power consumption mode switching request. The target frequency can be lower than the original frequency. The target frequency can be ½, ¼, ⅙, or ⅛ of the original frequency. A target frequency can be selected as needed to be pre-stored in memory for use. When not responding to the power consumption mode switching request, the first device may not receive the power consumption mode switching request. The user may not trigger the sleep mode or low-power consumption mode, or the second device and the first device can continue to have the operation signal interaction.

At 1014, the control register performs counting or countdown based on the target frequency and unit.

The control register can have a counting function. After receiving the target frequency and the corresponding unit, the control register can perform counting or countdown according to the target frequency and send the counting result to the execution module of the processor of the first device.

At 1015, when the counting or countdown ends, the processor of the first device processes the signal of the second device.

After receiving the signal indicating the end of counting or countdown of the control register, the execution module of the processor of the first device can process the signal of the second device again.

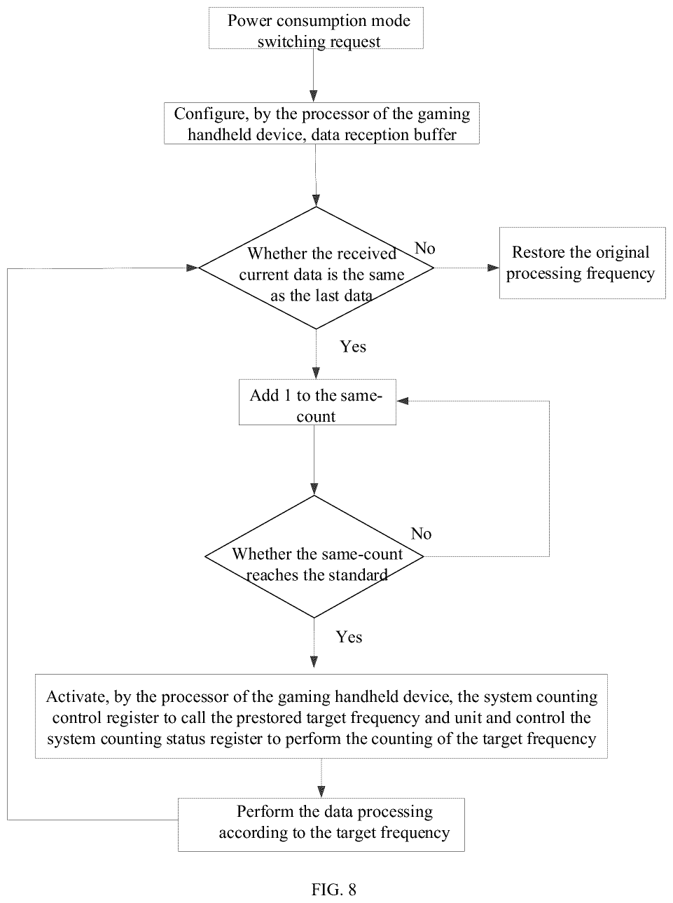

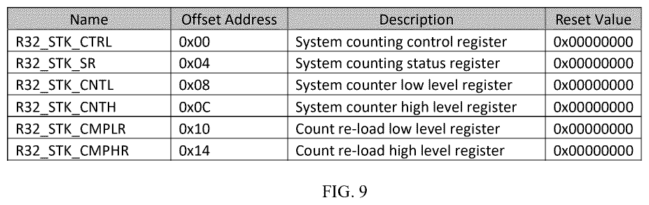

Referring to FIGS. 8 and 9, based on one trigger condition in the power consumption switching request, the processing method includes the following steps based on the above content.

When the gaming handheld device receives all status signals sent by the controller and processes the status signals at the original frequency (e.g., 1 s/time), the processor of the gaming handheld device can compare the received signals. If the currently received data is the same as the previous data, same-count can increase by 1 until the same-count reaches a preset threshold, e.g., 10 or 20. Then, the currently received signals can be determined to belong to the target signal. The processor of the gaming handheld device can activate the system count control register to call the preset target frequency and the unit, e.g., 15 s/time. That is, the processing frequency of the gaming handheld device for the status signals sent by the controller can be lowered to 15 s/time. The original frequency can the target frequency can be set to the system count low-level register and the system count high-level register. Then, the system count control register can send the target frequency and the unit to the system count control register for counting, i.e., counting or countdown. The process can be configured in a counting and recalling low-level register or a counting and recalling high-level register. The configuration content of the register can be easily understood by those skilled in the art and is not repeated here. Then, the execution module of the processor of the gaming handheld device can process the signals sent by the controller according to the target frequency. For example, the controller can be awakened every 15 seconds for data processing until the currently received data is detected not to belong to the target signal, and the original frequency can be recovered. In addition, the mistouch signal can also be detected and compared in the process. After the gaming handheld device switches to the second mode, the processor of the gaming handheld device can still compare the received signals. If the currently received data is detected to be different from the last received data, a count of different times can be increased by 1 until the different count reaches a threshold, e.g., 2 or 5. Then, the currently received signal can be determined not to belong to the mistouch signal. The gaming handheld device can restore the original frequency. On the contrary, if the count of different times is only 1, the signal can be determined to be a mistouch signal, and the gaming handheld device may not be awakened. Thus, after the gaming handheld device switches to the second mode, even if the user or another external item touches the controller when the user is not intend to operate the controller, the gaming handheld device can determine whether the received signal is a mistouch signal based on the comparison of the above signal to reduce the risk of mistouch wake-ups.

In the third method, step 101 can also include switching the first device from the signal processing frequency the same as the signal transmission frequency of the second device to a frequency at which the transmission signal of the second device.

In some embodiments, based on the power consumption switching request, the processor of the first device can directly reduce the processing frequency of the first device for the signal transmitted by the second device to zero. For a specific description, reference can be made to step 1013. The target frequency can be zero. The subsequent processing method can refer steps 1013 and 1014, which can be easily understood and are not repeated here.

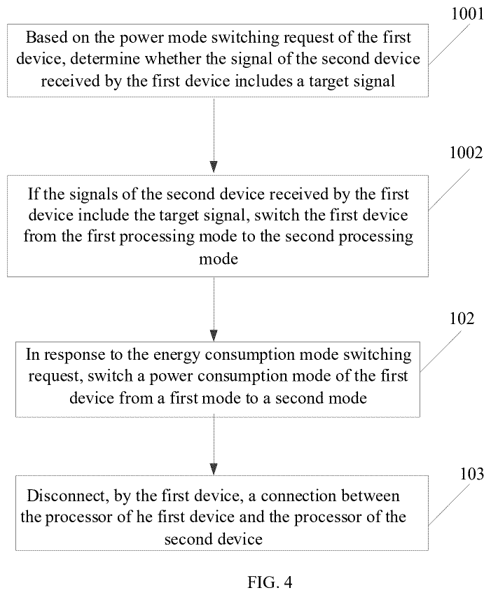

Further, referring to FIG. 4, to adapt to the situation when the user leaves and does not operate the second device for a long time, or the first device subsequently triggers the power consumption mode switching request, step 101 of embodiments of the present disclosure includes the following steps.

At 1001, based on the power consumption mode switching request of the first device, whether the signal of the second device received by the first device includes a target signal is determined.

Before switching the processing mode, the first device can determine whether the signals sent by the second device received by the first device include the target signal. The target signal can include a signal that exceeds a specified repetition count, an abnormal signal, or a disordered command. If the signals sent by the second device to the first device include the target signal, the signal can be indicated to be not an operation signal of the user but a status signal sent by the second device periodically to the first device.

At 1002, if the signals of the second device received by the first device include the target signal, the first device is switched from the first processing mode to the second processing mode.

For the method for switching the first device from the first processing mode to the second processing mode, reference can be made to the first, second, and third setting methods, which are not repeated here. Under this setting method, for the method corresponding to step 102, reference can be made to the above, which is not repeated here.

Further, step 1001 can include the following steps.

The processor of the first device can compare the current signal sent by the second device with the last signal sent by the second device. If the current signal of the second device is the same as the last signal of the second device, the same-count can be increased by one. If the same-count of the signals sent by the second device reaches a specified value, the current signal sent by the second device can be the target signal.

Comparing the current signal of the second device and the last signal of the second device can include at least comparing the signal type, quantity, and represented content. The specified value can be adjusted as needed. If the judgment result in step 1001 does not include the target signal, the processor of the first device can be awakened to process the signal sent by the second device at the original frequency. For example, if the signal sent by the second device includes 90 bytes of valid data (i.e., a data format of 9×80 bits), the comparison methods can include the following methods.

In the first comparison method, each bit can be compared one by one to determine whether data at each bit is consistent. If data at each bit is consistent with data at other bits, the data at each bit can be determined to be consistent, otherwise the data at each bit can be determined to be inconsistent.

In the second comparison method, whether the numbers of 1 and 0 in the data are consistent can be determined. If the numbers are consistent, the data can be determined to be consistent and otherwise inconsistent.

In the third comparison method, data at each bit can be compared for the data of the first 5 groups. If the data of the first 5 groups is consistent, numbers of 1 and 0 in the data of the last 4 groups can be compared. If the data of the first 5 groups is inconsistent, the data can be determined to be inconsistent. If the comparison results of the first 5 groups and the last 4 groups are consistent, the data can be determined to be consistent.

Due to external interference, such as electromagnetic or crosstalk, the signals sent by the controller can be affected and deviate from the encoding rule sent by the controller. For example, according to the encoding rule of the controller, the data sent by the controller can be 0000. However, after being affected by the external interference, the controller can send 0001. Although the data received by the gaming handheld device is different from the data 0000 of the last time, 0001 can be corrected to 0000. However, the signal sent to the gaming handheld device can still be 0001. Then, the gaming handheld device can determine that the signal sent by the gaming handheld device does not match reality. Thus, the current data can be determined to be an abnormal signal or a disorder command.

Embodiments of the present disclosure provide an electronic device, including a processor. The processor can store a program. When the program is running, the electronic device can be switched from the first processing mode to the second processing mode based on the power consumption mode switching request of the electronic device. In the first processing mode, the processing frequency of the electronic device for the received signal from the second device can be the first frequency. In the second processing mode, the processing frequency of the electronic device for the received signal from the second device can be the second frequency. The second frequency can be lower than the first frequency. In response to the power consumption mode switching request, the power consumption mode of the electronic device can be switched from the first mode to the second mode. The power consumption of the second mode can be lower than the first mode.

In some embodiments, the electronic device can be the first device in FIG. 1, which can include but is not limited to a terminal device, such as a gaming handheld device, a cell phone, or a laptop computer. The electronic device can include a processor inside the electronic device. The processor can store the processing method in the above embodiments.

In some embodiments, the electronic device of embodiments of the present disclosure can further include a first port. The first port can be electrically connected to the processor. The first port can be configured to transmit the target instruction. The first port can be a GPIO or PCIE port configured in the processor of the first device. The first port can be signal-connected to the second device through a cable to transmit the target instruction. The target instruction can include the device status switching instruction. Then, the processor and the first port of the first device and the processor of the second device can form the second channel above, without modifying the data transmission and reception program of the processor of the first device to simplify the design. The first port can include an existing port in the processor of the first device or can be additionally added. The first port can be connected via a cable.

Embodiments of the present disclosure further provide an electronic device. The electronic device can include a memory and a processor. The memory can store a computer program running by the processor that, when the computer program is executed by the processor, causes the processor to perform the data processing method of any embodiment above.

Embodiments of the present disclosure further provide a computer-readable storage medium. The storage medium can include a stored program. When the program is executed, the device including the storage medium can be controlled to perform the data processing method above.

Embodiments of the present disclosure further provide a computer program product. The computer program product can be tangibly stored on a computer-readable medium and include computer-executable instructions that, when executed, cause at least one processor to perform the data processing method above. The solutions of embodiments of the present disclosure can have the corresponding technical effects of the method embodiments, which are not repeated here.

The computer storage medium of embodiments of the present disclosure can be a computer-readable signal medium, a computer-readable storage medium, or a combination thereof. The computer-readable medium can include, but is not limited to, electrical, magnetic, optical, electromagnetic, infrared, or semiconductor systems, apparatuses, or devices, or any combination thereof. The computer-readable storage medium can include, but is not limited to, an electrical connection having one or more wires, a portable computer magnetic disc, hard drive, Random Access Memory (RAM), Read-Only Memory (ROM), Erasable Programmable Read-Only Memory (EPROM or flash memory), optical fibers, Portable Compact Disc Read-Only Memory (CD-ROM), optical storage devices, magnetic storage devices, or any suitable combination thereof.

In the present disclosure, the computer-readable storage medium can include any tangible medium that contains or stores a program. The program can be used by or in connection with an instruction execution system, apparatus, or device. In the present disclosure, the computer-readable signal medium can include a data signal in a baseband or propagated as a part of a carrier signal, which carries computer-readable program codes. The propagated data signal can include a plurality of formats and include, but is not limited to, an electromagnetic signal, an optical signal, or a combination thereof. The computer-readable signal medium can also include any computer-readable medium in addition to the computer-readable storage medium. The computer-readable medium can send, propagate, or transmit the program configured to be used by or in connection with the instruction execution system, apparatus, or device. The program codes included in the computer-readable medium can be transmitted in any suitable medium, including, but is not limited to wireless, antenna, optical fibers, RF, etc., or a combination thereof.

Although the present disclosure is described in terms of embodiments, each embodiment does not necessarily include only one independent technical solution. The description of the specification is merely for clarity. Those skilled in the art should consider the specification as a whole. The technical solutions of embodiments of the present disclosure can be suitably combined to form other embodiments understood by those skilled in the art.

The above are merely some embodiments of the present disclosure. The scope of the present disclosure is not limited to this. Those skilled in the art can easily think of modifications or replacements within the scope of the present disclosure. These modifications and replacements are within the scope of the present disclosure. Thus, the scope of the present disclosure can be conformed to the scope of the appended claims.

The above embodiments are merely exemplary embodiments of the present disclosure and are not intended to limit the present disclosure. The scope of the present disclosure is defined by the appended claims. Those skilled in the art can make various modifications or equivalent substitutions within the essence and scope of the present disclosure. Such modifications or substitutions should also be within the scope of the present disclosure.

What is claimed is:

1. A processing method comprising:
based on an power consumption mode switching request of a first device, switching the first device from a first processing mode to a second processing mode, wherein in the first processing mode, a processing frequency of the first device for a signal received from a second device is a first frequency, in the second processing mode, the processing frequency of the first device for the signal received from the second device is a second frequency, and the second frequency is lower than the first frequency; and
in response to the power consumption mode switching request, switching a power consumption mode of the first device from a first mode to a second mode, wherein the second mode has lower power consumption than the first mode.

2. The processing method according to claim 1, wherein switching the first device from the first processing mode to the second processing mode based on the power consumption mode switching request of the first device includes:
based on the power consumption mode switching request of the first device, the first device sending a target instruction to the second device; and
in response to the target instruction, a processor of the second device controlling a mode setting register of the second device to switch from a first status to a second status, wherein in the first status, the first device is in the first processing mode, and in the second status, the first device is in the second processing mode.

3. The processing method according to claim 2, wherein the first device sending the target instruction to the second device based on the power consumption mode switching request of the first device includes:
a processor of the first device sending the target instruction to the processor of the second device via a first channel; or
the processor of the first device sending the target instruction to the processor of the second device via a second channel, wherein the second channel is different from the first channel and is only configured to transmit the target instruction.

4. The processing method according to claim 1, wherein switching the first device from the first processing mode to the second processing mode based on the power consumption mode switching request of the first device includes:
a processor of the first device disconnecting a connection with a processor of the second device.

5. The processing method according to claim 1, wherein switching the first device from the first processing mode to the second processing mode based on the power consumption mode switching request of the first device includes:
a processor of the first device activating a status register, wherein the status register calls and sends a preset target frequency and unit of the status register to a control register;
the control register performing counting or countdown according to the target frequency and unit; and
in response to the counting or countdown being completed, the processor of the first device processing the signal of the second device;
wherein the target frequency is lower than the processing frequency of the processor of the first device for the signal of the second device when the power consumption mode switching request is not responded to.

6. The processing method according to claim 1, wherein switching the first device from the first processing mode to the second processing mode based on the power consumption mode switching request of the first device includes:
based on the power consumption mode switching request of the first device, determining whether the signal of the second device received by the first device includes a target signal; and
in response to the signal of the second device received by the first device including the target signal, switching the first device from the first processing mode to the second processing mode.

7. The processing method according to claim 6, wherein:
the target signal includes a signal exceeding a specified repetition count, an abnormal signal, and/or an out-of-order command signal.

8. The processing method according to claim 6, wherein determining whether the signal of the second device received by the first device includes the target signal includes:
the processor of the first device comparing a current transmission signal of the second device with a last transmission signal of the second device;
in response to the current transmission signal of the second device is the same as the last transmission signal of the second device, a same-count incrementing by 1; and
in response to the same-count of the transmission signal of the second device reaching a specified value, the current transmission signal of the second device being the target signal.

9. The processing method according to claim 1, wherein switching the first device from the first processing mode to the second processing mode based on the power consumption mode switching request of the first device includes:
the first device being switched from a signal processing frequency the same as a signal transmission frequency of the second device to not processing the transmission signal of the second device.

10. An electronic device comprising:
one or more processors; and
one or more memories storing a program that, when executed by the one or more processors, causes the one or more processors to:
based on an power consumption mode switching request of a first device, switch the first device from a first processing mode to a second processing mode, wherein in the first processing mode, a processing frequency of the first device for a signal received from a second device is a first frequency, in the second processing mode, the processing frequency of the first device for the signal received from the second device is a second frequency, and the second frequency is lower than the first frequency; and
in response to the power consumption mode switching request, switch a power consumption mode of the first device from a first mode to a second mode, wherein the second mode has lower power consumption than the first mode.

11. The device according to claim 10, wherein the one or more processors are further configured to:
based on the power consumption mode switching request of the first device, send, by the first device, a target instruction to the second device; and
in response to the target instruction, control, by a processor of the second device, a mode setting register of the second device to switch from a first status to a second status, wherein in the first status, the first device is in the first processing mode, and in the second status, the first device is in the second processing mode.

12. The device according to claim 11, wherein the one or more processors are further configured to:
send, by a processor of the first device, the target instruction to the processor of the second device via a first channel; or
send, the processor of the first device, the target instruction to the processor of the second device via a second channel, wherein the second channel is different from the first channel and is only configured to transmit the target instruction.

13. The device according to claim 10, wherein the one or more processors are further configured to:
Disconnecting, a processor of the first device, a connection with a processor of the second device.

14. The device according to claim 10, wherein the one or more processors are further configured to:
activate, a processor of the first device, a status register, wherein the status register calls and sends a preset target frequency and unit of the status register to a control register;
perform, by the control register, counting or countdown according to the target frequency and unit; and
in response to the counting or countdown being completed, process, the processor of the first device, the signal of the second device;
wherein the target frequency is lower than the processing frequency of the processor of the first device for the signal of the second device when the power consumption mode switching request is not responded to.

15. The device according to claim 10, wherein the one or more processors are further configured to:
based on the power consumption mode switching request of the first device, determine whether the signal of the second device received by the first device includes a target signal; and
in response to the signal of the second device received by the first device including the target signal, switch the first device from the first processing mode to the second processing mode.

16. The device according to claim 15, wherein:
the target signal includes a signal exceeding a specified repetition count, an abnormal signal, and/or an out-of-order command signal.

17. The device according to claim 15, wherein the one or more processors are further configured to:
compare, the processor of the first device, a current transmission signal of the second device with a last transmission signal of the second device;
in response to the current transmission signal of the second device is the same as the last transmission signal of the second device, add a same-count by 1; and
in response to the same-count of the transmission signal of the second device reaching a specified value, determine the current transmission signal of the second device to be the target signal.

18. The device according to claim 10, wherein the one or more processors are further configured to:
switch the first device from a signal processing frequency the same as a signal transmission frequency of the second device to not processing the transmission signal of the second device.
